(19) United States
(12) Patent Application Publication
(10) Pub. No.: US 2006/0234675 A1
(43) Pub. Date: Oct. 19, 2006

(54) Method and apparatus for authentication scheme and for network access using an electronic frank

(76) Inventor: Philip Flavin, Suffolk (GB)

Correspondence Address: NIXON & VANDERHYE, PC, 901 NORTH GLEBE ROAD, 11TH FLOOR, ARLINGTON, VA, 22203, US

(21) Appl. No.: 10/563,910

(22) PCT Filed: Jun. 9, 2004
(86) PCT No.: PCT/GB04/02438

§ 371 Date: Jan. 10, 2006

(30) Foreign Application Priority Data
Jul. 11, 2003 (GB) 0316293.0

(51) Int. Cl. H04M 3/16; H04M 1/68

(52) U.S. Cl. 455/410

(57) ABSTRACT

An electronic frank, e.g. electronic stamp, in use arranged to be associated with data to be transmitted over a telecommunications network (405) to an intended recipient at a destination address (408), the electronic frank comprising a data structure containing a set of at least one authenticated parameter-value, each parameter-value associated with a characteristic of the data to be transmitted, the data structure arranged in use to be processed by an apparatus (406) arranged to forward the data towards the intended recipient it is transmitted over the telecommunications network, whereby the apparatus is able to determine from the contents of the data-structure if the electronic frank conforms to at least one predetermined criteria prior to the data being transmitted to the destination address.

This invention relates to an authentication scheme for data transmission systems, particularly electronic mail systems (commonly termed e-mail). The invention relates particularly to an authentication scheme which inhibits the sending of unsolicited e-mail by using a franking process. The franking process enables a sender of an e-mail to attach an electronic frank (or equivalently an electronic stamp) to the communication sent which can, for example, verify that the e-mail is not unwanted “spam” e-mail and/or authenticate the source of the e-mail.

Each user of an e-mail system has a terminal which, via a telecommunications link, can send messages to (and receive messages from) a server computer which can forward it (possibly via a further such server) to another user's terminal. Commonly such a terminal takes the form of a general-purpose desktop computer provided with software which performs the e-mail function.

Many proprietary programs are available on the market for this purpose (for example Microsoft Exchange, Microsoft Outlook, or Lotus Notes), all of which offer the user a word-processing facility to compose messages via a keyboard, and to enter the e-mail address of the intended recipients, and other parameters such as degree of urgency. Other common facilities include the ability to “attach” a computer file such as a text document or image file, a reply facility which automatically enters as the destination address(es) the address (and if desired the addresses of other recipients—“reply to all”) of the sender of an earlier incoming e-mail, often repeating also the text of the incoming e-mail.

Despite the undoubted utility of e-mail systems, the very ease of their use carries with it the risk of users sending too many e-mails. Sometimes e-mails are sent when perhaps a telephone call or instant message would suffice. The provision of a “reply to all” facility may result in e-mails being sent to recipients who have no need of them. Such problems are addressed in our co-pending United Kingdom patent application number GB 0223876.4, a copy of which is filed herewith.

Another problem occurs when a large number of unsolicited e-mails are sent to a recipient. Unsolicited e-mail, for example e-mail which as been sent to a number of recipients as part of marketing campaign, is commonly referred to as “spam”. Most “spam” contains marketing information such as advertisements for products and services which are sent using large mailing lists. The mailing lists may contain e-mail addresses which have been obtained via a person accessing a particular web-site. This results in many persons receiving e-mail which is not of interest to them. The increasing amount of spam e-mail sent creates problems for the individual receivers as the unsolicited e-mails drain the recipients e-mail resources. For example, a mail server can spend more time processing unwanted e-mail than more legitimate e-mail, and e-mail delivery can be slowed as a result. Also, the amount of storage space available for desired data and e-mails in the recipient's inbox is reduced by the presence of unwanted e-mail. The numbers of unsolicited e-mails in a recipients inbox can in some cases be sufficiently high to render the task of locating desired e-mails irksome and tedious. Also, certain “spam” e-mails may be inappropriate in that they relate to adult material which is sent to minors etc., or contain viruses which can cause damage i the recipient activates the virus, for example, by opening an attachment to an e-mail.

The prior art has presented several solutions to the problems outlined above. For example, filtering out subsequent spam by removing mail from a “spam” sender's e-mail address in the user's in-box. This technique has limited usefulness. Firstly, the spam e-mail is still downloaded from the e-mail server in the normal manner and this takes up connection time which can be costly and slow, especially if the spam contains attachments. Secondly, even when spam e-mails have been filtered out of the in-box of the recipient, they are still usually accessible in other folders prior to permanent deletion which can be undesirable if the recipient is a minor and the spam e-mail is suitable only for adults. Finally, spam e-mail senders are able to randomly generate e-mail addresses which will not be picked up by the filter until after a user has reconfigured the filter to remover the new spam e-mail address. This effectively renders spam e-mail filtering a user's in-box when based on the sender's address redundant. Other solutions exist in which the inbox contents are filtered based on certain key words or other criteria but these are not satisfactory as they can also remove wanted e-mails.

Accordingly, filters which remove the spam e-mail from their inbox are generally less than 100% effective and provide no real deterrent to the sender's of spam e-mail to cease sending spam e-mail.

At the corporate level, corporate bodies whose members/employees are recipients of spam e-mail from sources external to the corporate intranet may wish to apply filters at the corporate mail server/gateway to mitigate the effect the spam e-mail has on the internal e-mail resources. This also reduces the amount of time recipients spend filtering their e-mail at their own inbox. However, corporate level schemes which employ filters to block e-mail from being delivered if the e-mail contains one or more key word can be unsatisfactory as they may remove e-mail which an employee wishes to receive.

Accordingly, it is therefore desirable if e-mail can be authenticated as being from a particular source which the intended recipient will find acceptable. It is also desirable if unsolicited or “spam” e-mail can be filtered out from a user's mailbox prior to the user reading it based on preferences determined by the user. It is also desirable if solicited e-mail can be guaranteed to be delivered to a recipient, preferably within a predetermined amount of time when such filtering processes are used. It is particularly advantageous, if the spam e-mail filter process actually deters the spam e-mail sender from sending spam e-mail.

Whilst it is known to filter e-mail from a spam sender at the e-mail server, i.e., prior to a user receiving the e-mail, this can be a complex process which may delay in e-mail delivery. United States Patent Application Number US 2001/0023432 “Method and Apparatus for enabling a fee to be charged to a party initiating an electronic mail communication when the party is not on an authorisation list associated with the party to whom the communication is directed” by Council et al, describes an IPS server which analyses a datagram to determine if the source address is on a list of authorised source addresses for a destination address. If the source address is not on the list the method provides the sending party with the option of paying a fee to send an e-mail to that recipient. However, this solution has the disadvantage that the IPS server is required to maintain a list of authorised senders and must consult this list for each e-mail recipient. This is a very complex process given the amount of e-mail traffic and recipients each IPS server must support.

The invention seeks to obviate and or mitigate the above problems associated with unsolicited e-mail by providing a scheme in which a sender of an e-mail is required to electronically authenticate their e-mail prior to sending the e-mail. This has a particular advantage in that it can discourage senders of spam e-mail by associating a “cost” value with each e-mail sent.

Advantageously, this removes the necessity for the server to consult a list of approved senders which reduces the drain on the server's resources and reduces the level of delay incurred processing e-mail.

According to a first aspect of the present invention there is provided an electronic frank, in use arranged to be associated with data to be transmitted over a telecommunications network to an intended recipient at a destination address, the electronic frank containing information arranged to be authenticated whereby the electronic frank can be validated and processed to confirm if the frank meets at least one predetermined delivery criteria, the electronic frank being thus validated prior to the data being transmitted to the destination address.

The information may be conveyed using a predetermined format having various fields which can be assigned certain predetermined parameter values, for example, the identity number of the electronic frank, that the sender has been authenticated, the actual address of the sender, whether the frank is a personal frank issued originally by the intended recipient, the number of uses permitted of the frank, the cost-value of the frank etc. At least one of these parameter values may be pre-authenticated, i.e., authenticated by the stamp issuing body.

Preferably, the data to be transmitted comprises an electronic mail message, i.e.,“e-mail”.

Preferably, the electronic frank comprises a data attachment to the electronic mail message.

Preferably, the electronic frank data structure comprises a digital wrapper certificate type data structure.

Preferably, the criteria for the data to be transmitted to the destination address is determined by the intended recipient.

Preferably, the electronic frank is associated with a predetermined cost-value.

At least one predetermined criteria to which the electronic frank must conform may be for the cost-value of the electronic frank to be the correct value associated with the data to be sent to the recipient.

The cost-value may be determined by at least one characteristic of the data to be transmitted to the intended recipient.

A characteristic of the data may be taken from the group including: the destination address of the intended recipient of the data; the address of the sender of the data; the identity of the sender of the data, the number of copies of the data which are being sent by the sender of the data; the bandwidth of data; the content of the data; and the number of uses of the electronic frank.

Preferably, the cost value is a monotonically increasing function of the size of the data to be transmitted.

The electronic frank may be issued by the intended recipient of the data to be transmitted.

This can allow an individual to have control over the data they receive over the internet by only issuing electronic franks to trusted other parties.

Alternatively, the electronic frank may be generated by a third party who authenticates at least one characteristic of the data as being valid.

This may enable a recipient to be reassured that they will not receive unwanted spam e-mail if the third party issuing the electronic stamps adopts a policy which refuses to issue electronic stamps to senders of spam e-mails.

A second aspect of the invention provides an electronic frank arranged to be capable of being attached to data comprising e-mail to be sent by a user of an electronic mail client application to an intended recipient via a communications network, the electronic frank having a data structure which conforms to a predetermined set of criteria which enables certain franking rules to be applied when the electronic frank is processed by apparatus in the network, wherein the franking rules determining whether the recipient receives the e-mail are determined by the recipient.

The electronic frank may be associated with a cost-value dependent on a set of at least one predetermined characteristics of the e-mail to which the frank is to be attached.

The data structure may authenticate the sender of the e-mail using a digital wrapper type certificate.

The electronic frank may be issued by an application which is operable to increase the cost value in the event of the e-mail being marked with a marker indicative of the priority of transmission to the intended recipient.

The electronic frank may be issued by an application remotely accessed by the sender, the application being controlled independently by a third party who authenticates at least the identity of the sender prior to issuing the sender with the electronic frank.

A third aspect of the invention comprises a terminal arranged to enable a user to send data electronically to an intended recipient over a telecommunications network, the terminal comprising: means for generating data electronically; means operable to associate an electronic frank according to any one of the first or second aspects with the data prior to its being transmitted; means for displaying to a user of the terminal a quantitative visual indication representative of the frank; and means for transmitting the franked data via a telecommunications network to a destination address.

The terminal may further comprise means operable to authenticate at least one parameter-value of the frank prior to the franked data being sent by the apparatus and to include this authentication information within the data structure of the frank.

At least one parameter-value authenticated may include the address of the sender and/or the identity of the sender and/or that the franking cost-value of the electronic frank is the appropriate amount.

The means operable to associate an electronic frank with the data may comprise means to automatically generate the frank and to automatically attach the frank to any data to be transmitted.

A fourth aspect of the invention comprises apparatus forming part of a telecommunications network and arranged to forward e-mail to a destination address, the apparatus further comprising: data validation means arranged to validate an electronic frank according to any one of the first or second aspects which has been attached to e-mail to be sent to a recipient over a communications network; processing means arranged to process an electronic frank to determine if the electronic frank conforms to a set of predetermining franking rules, said set of predetermined franking rules requiring at least that the e-mail not be delivered to the recipient if no electronic frank is attached.

Preferably, the apparatus according to the fourth aspect of the invention comprises a server. Alternatively, the apparatus could comprises a firewall. Preferably the server and/or firewall performing the frank validation process comprise apparatus associated with the recipients e-mail client. Alternatively, at least some steps in a frank validation process comprising authenticating the frank may be performed by the sender's e-mail server or e-mail client or by a trusted source providing the frank.

The apparatus may comprise the outgoing e-mail server of the sender. This can enable incorrectly franked e-mail to be returned more rapidly to the sender

The apparatus may comprise the incoming e-mail server of the recipient of the e-mail. This can enable e-mail to be rejected prior to the recipient receiving the e-mail in their e-mail client application in-box.

The apparatus may comprise the e-mail client of the recipient of the e-mail. This can enable a recipient to see rejected e-mails optionally.

A fifth aspect of the invention provides apparatus forming part of a telecommunications network comprising: means arranged to authenticate that the contents of an electronic frank according to any of the first or second aspects of the invention is validly based on the contents of the data to be transmitted.

A sixth aspect of the invention provides a method of generating an electronic frank as claimed in any one preceding claim, the electronic frank comprising a data structure conforming to a predetermined data template, the method comprising the steps of: receiving a request for an electronic frank from a requesting entity; querying the requesting entity for information to determine certain parameter-values to be contained within the data structure; processing the information provided by the requesting entity; generating the data structure using the processed information to determine at least one parameter-value pair associated with a characteristic of the data to be sent; and issuing the electronic franking data to the requesting entity.

The electronic frank can thus contain information in the data structure such as a unique identifying number.

A seventh aspect of the invention provides a method of sending data over a telecommunications network to an intended recipient at a destination address, the method comprising the steps of: preparing the data for transmission; obtaining an electronic frank according to any one of the first or second aspects to authenticate the data to be transmitted; and attaching an electronic frank to the data.

The electronic frank data may be associated with a cost-value which is charged to the user.

An eighth aspect of the invention provides a method of filtering data sent over a telecommunications network towards an intended recipient, the method comprising, at a communications apparatus arranged to forward the data towards the intended recipient, the steps of: receiving the data for forwarding to the intended recipient; processing the data to determine if it is associated with an electronic frank according to any one of the first or second aspects; and, if no electronic frank is found and/or if the electronic frank has a data structure which does not conform to a set of at least one predetermined criteria, preventing the data from being forwarded to the intended recipient, and, otherwise forwarding the data to the intended recipient.

A ninth aspect of the invention provides a mail server arranged to implement the method according to the eighth aspect.

A tenth aspect of the invention provides a firewall component arranged to implement the method according to the eighth aspect.

An eleventh aspect of the invention relates to an electronic mail system comprising a server and a plurality of terminals, at least some of said terminals being in accordance with the third aspect of the invention, wherein the data to be sent comprises an electronic mail message. The server may include storage means storing an allocated numerical budget indication for each of a plurality of terminals and means operable upon receipt of an electronic mail message from a terminal to decrement the stored budget in respect of that terminal by the amount of computed cost value.

A twelfth aspect of the invention relates to a signal in a communications network, the signal comprising data and an electronic frank according to any one of the first or second aspects of the invention.

One aspect of the invention can provide an e-mail service to a user who does not have prearranged access to a communications network. For example, a thirteenth aspect of the invention relates to: a method of providing bandwidth for a data transmission service over a communications network to a user who does not have prearranged access to the communications network at that bandwidth, the method comprising the steps of: associating an electronic frank according to any one of claims 1 to 17 with data to be sent using said data transmission service, said electronic frank being associated with a cost-value; providing a data transmission service to send and/or receive franked data over said communications network at said bandwidth.

For example, the communications network may comprise the internet, and the data transmission service may be provided by an internet access provider. Advantageously, this enables a user to have a pay-and-go type of internet access account, in the manner currently provided for mobile phone users. In this way, a method can be provided in which a user is provided with means to indicate the desire to send an e-mail via an e-mail client application; the user is provided with means to purchase an electronic frank according to any one of the first or second aspects of the invention, wherein the electronic frank is associated with the data and a cost-value associated with the electronic frank is charged to the user, enabling the user's e-mail client application to send and receive franked e-mail via a server connected to the internet.

A fourteenth aspect of the invention relates to software comprising suite of one or more computer programs, the software arranged in use to be run on one or more computer type devices to implement any method aspect of the invention.

Other aspects of the invention are defined in the sub-claims. The preferred features of the invention as described hereinabove and/or in the sub-claims may be combined in an appropriate manner with any independent claim and/or aspect as is apparent to those skilled in the art.

Some embodiments of the invention will now be described, by way of example, with reference to the accompanying drawings in which:

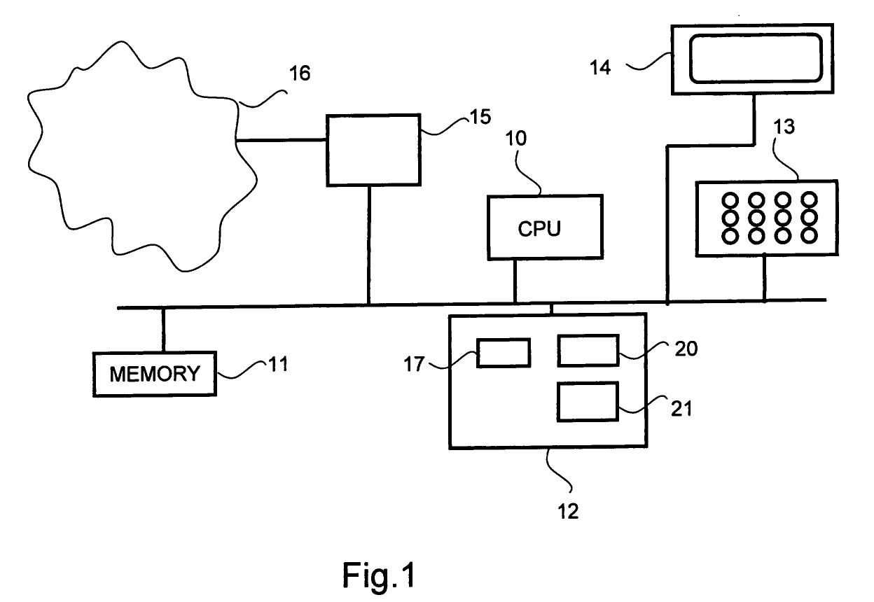

FIG. 1 shows schematically a terminal according to the invention;

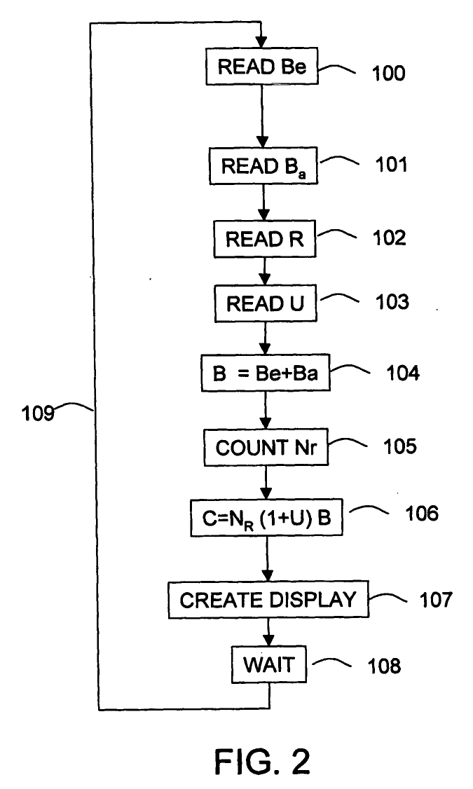

FIG. 2 shows schematically steps in a method of calculating the cost of an e-mail according to the invention;

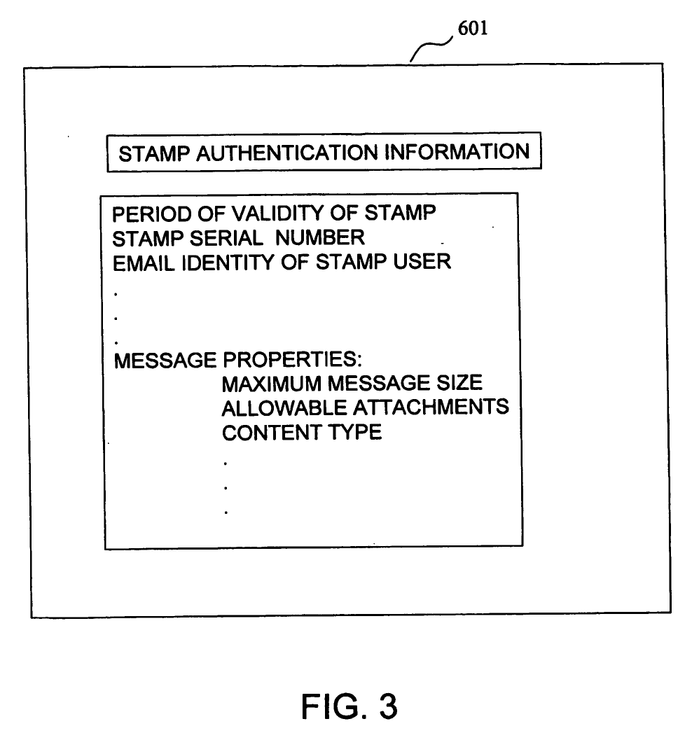

FIG. 3 shows schematically a data structure comprising an electronic frank;

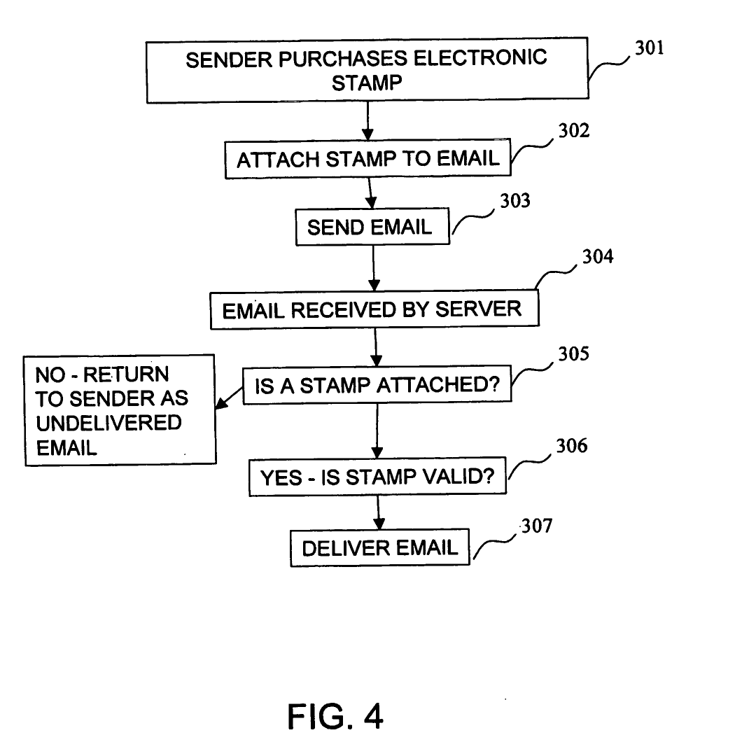

FIG. 4 shows schematically step in a method of franking a data transmission according to the invention;

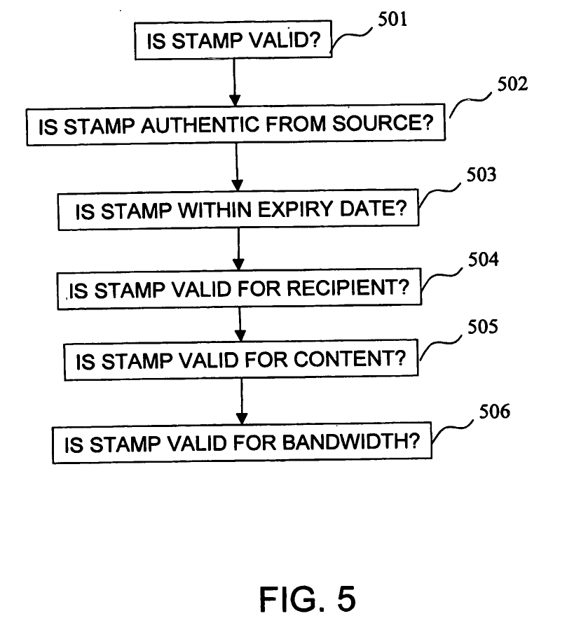

FIG. 5 shows schematically steps in a method of validating an electronic frank;

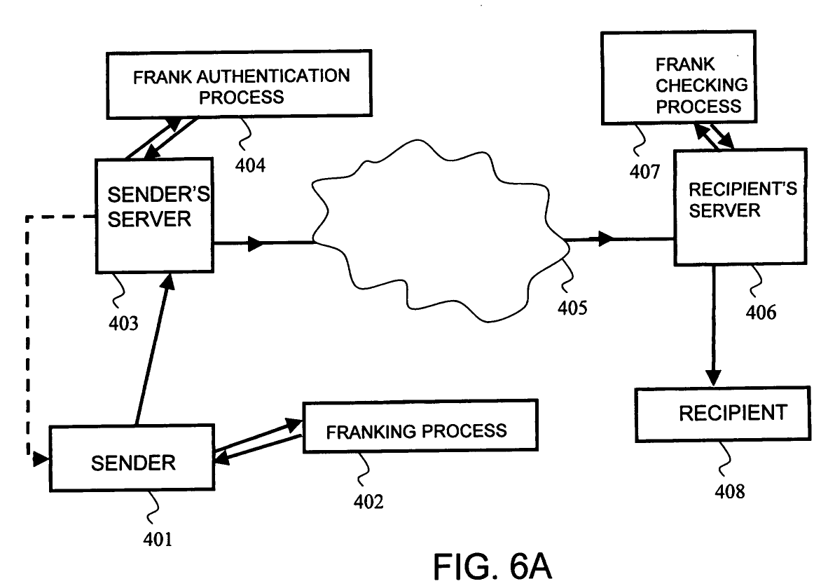

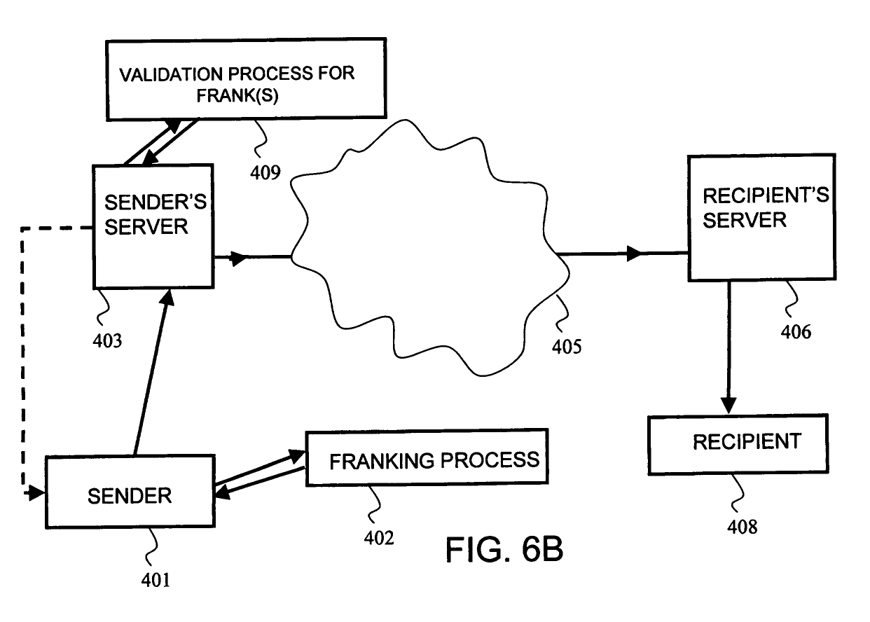

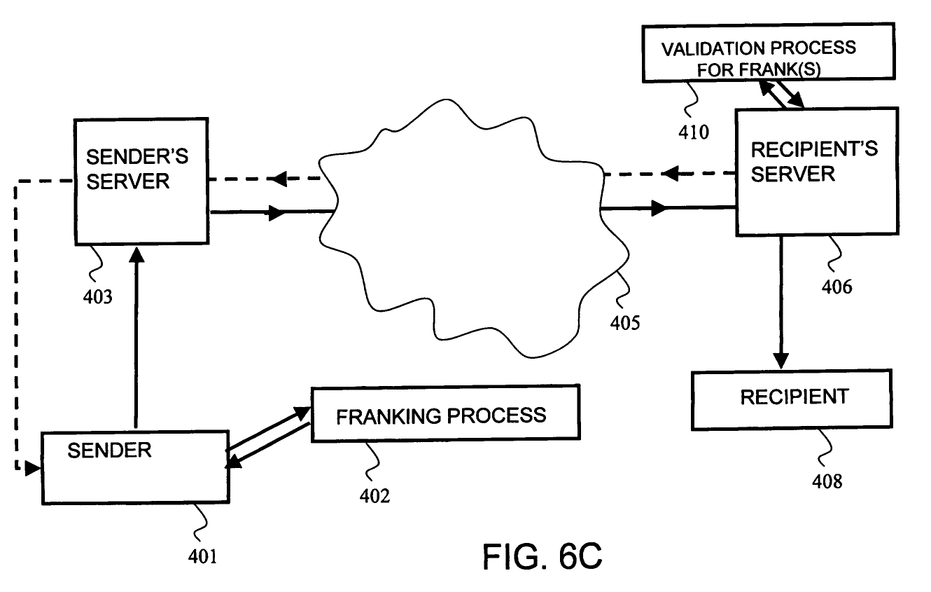

FIGS. 6A, 6B, and 6C show schematically apparatus arranged to implement steps in a method of franking data according to the invention.

The philosophy behind this invention is the realisation that there is too much e-mail sent with no consideration of the cost, both in terms of network cost and the recipients time to deal with them, of sending e-mails, and that a solution to this is to provide a mechanism whereby senders may be made aware of a ‘cost’ of sending. A further benefit of the invention is by making sender's aware of the cost of sending e-mails, sending unsolicited e-mail can be made too costly and/or cumbersome to be economically viable for the sender. A further benefit of the franking scheme according to the invention is that an intended recipient of data and/or e-mail is able to avoid downloading unwanted e-mail/data.

In FIG. 1, a terminal is shown schematically which is able to inter-work with a conventional e-mail server and other user terminals which can be the same as the terminal to be described, or can be conventional. The contains the usual computer components, that is a processor 10, memory 11, a disc store 12, keyboard 13, a display 14, and a network interface 15 for connection to a telecommunications network 16.

As well as the usual operating system programs, 17 the disc store 12 contains a conventional e-mail program 20 which may be one of those mentioned earlier, referred to here as the “main program”, and an additional program 21 (referred to in this description as the “ranking program”) to provide the additional functionality now to be described. Of course, rather than providing separate programs the two could be integrated into a single program or suite of programs, if so desired.

In one embodiment of the invention, the franking program comprises a cost program which links into the main program to access, while an e-mail is being or has been composed by the user, but before the e-mail has been sent, information about the e-mail, in particular, some or all of
the size of the e-mail in bytes (Bₑ);
the size of any attachments (Bₐ);
(or, the size B of the e-mail including any attachments);
the list of recipients R (or alternatively, a count N_{R} of the number of recipients);
any urgency/priority marking U applied to the e-mail of recipients.

The task of the cost program is to calculate, from these parameters, a quantitative indication, respectively a notional cost of sending the e-mail, and to display it on the display 14 perhaps in a separate window on the screen or (in the event of closer integration of the main and cost programs) as part of the display normally generated by the main program.

A number of possible algorithms may be envisaged for calculating a numerical cost measure C. The simplest would be the size of the e-mail, viz.
C=B=Bₑ+Bₐ

Noting however that whilst the loading on the network is proportional to the size of the e-mail, there will be a minimum time taken by a recipient to deal with the e-mail however short it is, a fixed charge Co might be added, whereupon
C=Cₒ+B
or
C=Cₒ+Bₑ+Bₐ

Other, non-linear functions of B might be chosen, to penalise very large e-mails. At all events, the cost measure C should be a monotonically increasing function of the size.

Naturally, the more recipients an e-mail is sent to, the greater the loading on both the network and the recipients' time, so we prefer to multiply the cost by the number of recipients.
e.g. C=N_{R}(Cₒ+Bₑ+Bₐ)

The urgency of the message may also be taken into account, especially if the network is arranged to provide faster transmission to e-mails so marked: even if it does not, the receipt of an urgent-marked e-mail may be more disruptive to the recipient's time. So for example, assuming an urgency marking if U=1 (urgent) or U=0 (normal) a cost measure might be
C=N_{R}(U+1)(Cₒ+Bₑ+Bₐ)

The cost value could be displayed directly as a number, or it could be scaled by a suitable fixed factor to give a number though to approximate to a real cost in pounds, euros, or dollars. Alternatively the display could take the form of a non-numeric display such as a bar whose length is proportional to the cost value C. High values could if desired be emphasised by the use of distinctive colours.

FIG. 2 of the accompanying drawings shows a flowchart for the cost program which comprises the following steps
100 Read Bₑ
101 Read Bₐ
102 Read list R
103 Read U
104 Compute B=Bₑ+Bₐ
105 Compute N_{R} (i.e. count the number of addresses in R)
106 Compute C=N_{R}(1+U)(Bₑ+Bₑ)
107 Generate the display
108 Wait for an update period (perhaps 1 second)
109 Go to step 100

As an enhancement to this system, each user is allocated a budget, that is, a total numerical allocation (per month, perhaps), which is recorded by the server providing him with e-mail service. Each time he sends an e-mail, the cost value C is subtracted from the budget. This may be achieved either

(a) by the terminal sending the cost value to the server at the time that the e-mail is sent: or

(b) by the server performing for itself the same calculation as described above.

The decremented budget could be used to warn the user (or his employer!) of excessive use, or, if desired, to automatically disable the sending of e-mails once it reaches zero.

In the event that the cost value is sent to the server, it could if desired be incorporated into the message so that rather than merely notifying the server it also reaches the recipient, where it might be used in a number of ways, such as the recipient filtering out “unstamped” messages, or for costing purposes, whether real or virtual such as the recipient receiving a credit for reading unsolicited mail, or the cost of forwarding a message for internal distribution could be borne by the originator rather than the first recipient.

For security, the cost value, or “stamp”, sent in this way may be encrypted, in the same way as a digital signature.

Anti-Span Application

The embodiment of the invention described above with reference to FIGS. 1 and 2 of the invention franks e-mail by attaching an “electronic frank”(a term used interchangeably herein with the term “electronic stamp”). The transmission of franked e-mail can inhibit the generation of spam e-mail.

Overview

By providing an e-mail system in which franked e-mail is sent, the sending of unsolicited e-mail can be inhibited in a variety of different ways. For example, an individual recipient could issue their own personal electronic franks so that only e-mail bearing their own personal frank is received in their inbox. Alternatively, an individual recipient could also subscribe to a service which only allows franked e-mail to be delivered, but which does not discriminate between franks issued by different sources.

For example, the electronic franks can be issued by a third party who authenticates the identity of the sender. For example, a trusted source such as one which provides digital wrapper certificate type authentication services could be used. Each frank could also associated with a cost value so that the sending of franked e-mails incurs a cost for the sender of the e-mail, which would inhibit the sending of email in the manner described above with reference to FIGS. 1 and 2 of the accompanying drawings. Sender's of spam email could be reported to the stamp issuing body and black-listed from obtaining more franks.

Unsolicited email could be inhibited or eradicated by providing further levels of control by way of delivery criteria which a stamp would need to meet before being sent on to its intended recipient. For example, one further level of control is for an individual recipient to set certain delivery criteria. Another would be for a group controlled set of deliver criteria to be set, for example, by an ISP for its subscribers for by a corporation for its employees.

In this way, there is no need to maintain a list of blocked senders. A server can trust the source of the frank (whether 3^{rd} party or the intended recipient) to have authenticated sufficient information on the sender and/or the data being sent and/or to have charged the sender a high enough cost-value. The server therefore just checks the data has been franked before sending it to the recipient.

The delivery criteria could be applied by any suitable apparatus capable of detecting the frank and processing the information it conveys. The apparatus, for example, could comprise the recipient's incoming mail server and/or firewall application or e-mail client application. An e-mail which is not franked or which has an electronic frank which does not conform with the delivery criteria will be rejected and returned to the sender and/or destroyed.

By franking e-mail and requiring each frank to incur a cost-value for the sender, the generation of computer viruses being sent as file attachments to e-mail can be inhibited. As an additional feature of an electronic frank, when the frank is associated with data which could contain a virus (e.g. an e-mail with an executable file attached to it), the electronic frank could incur a higher cost-value for the sender than a simple e-mail or an e-mail with a text file attached.

Incoming mail servers can then reject all unfranked e-mail without needing to perform any other filtering processes.

The Electronic Frank Authentication Scheme

FIG. 3 shows schematically an electronic frank according to one embodiment of the invention. The electronic frank may take the form and be generated in the same manner described herein above with reference to FIGS. 1 and 2 of the accompanying drawings. Different types of electronic frank may be generated by different sources in the manner described later below.

Electronic Frank Data Structure

The electronic frank comprises a data structure 601 shown schematically in FIG. 3 which contains information conforming to a predetermined data template. For example, in one embodiment of the invention, the electronic frank can be encrypted and takes a digital wrapper certificate type structure.

The data template provides a format for the information which enables one or more electronic frank verification process(es) to occur. As shown schematically by the embodiment of the invention shown in FIG. 3, the data template comprises a number of fields enabling information to be extracted and processed to determine if the electronic frank meets certain predetermined delivery criteria. In a preferred embodiment of the invention, each occupied field in the data structure comprises a parameter-value pair representing at least one of the following: a characteristic of the data being sent, a characteristic of the sender, a characteristic of the frank issuing body, a characteristic of the electronic frank itself.

According to the invention, a characteristic of the data being sent includes a characteristic of its method of deliver. In a preferred embodiment of the invention, a characteristic of the data being sent which could be described by the information conveyed by the electronic frank could be one of the following:

the size of the data;

the bandwidth requested to deliver the data;

the priority of the delivery mechanism to be used to deliver the data;

the type of data, e.g. if a text file, executable file, email text message alone, email with attachments (and then the type of attachments), video-type file, audio-type file, etc; and

the content of the data, e.g. music, film, for adults, for minors etc.

In a preferred embodiment of the invention, a characteristic of the sender which could be described by the information conveyed by the electronic frank could be one of the following:

the identity of the sender;

the address of the sender; and

information relating to the account of the sender from which the frank cost-value has been deducted.

In a preferred embodiment of the invention, a characteristic of the electronic frank issuing body which could be described by the information conveyed by the electronic frank could be one of the following:

if the frank is a personally issued frank allowing delivery only to the frank issuer;

the identity of the frank issuing body;

the address of the frank issuing body; and

whether the frank issuing body has performed any authentication of one or more characteristics described by the information conveyed by the electronic frank.

In a preferred embodiment of the invention, a characteristic of the electronic frank itself which could be described by the information conveyed by the electronic frank could be one of the following:
a serial number identifying the frank;
how the frank was issued;
a cost-value of the frank;
when the frank was issued;
the duration of validity of the frank;
the number of uses permitted of the frank;
details of which characteristics conveyed by the frank have been authenticated.

At least one of the characteristics described by the information conveyed by the electronic frank should already be authenticated, depending on the mode by which the frank was issued. For example, if a third party has issued the frank, then either the identity of the sender should have already been authenticated or the cost-value of the frank authenticated. The cost-value of the frank may have been prepaid by the sender prior to attachment to the actual data being franked. In such circumstances, the sender's mail application may have the facility to verify certain characteristics, for example, if the cost-value is appropriate for the size of data being sent.

In a preferred embodiment of the invention, the data structure includes information on one or more of the following: identifying the frank issuing body, when the frank was issued, how the frank was issued, the period of validity of the frank, an identifying serial number of the frank, the size of data for which the frank is to be used, the level of priority requested for delivery of the data, the type of type of data (i.e., audio, video, multi-media, games content, or the nature of any attachments to an e-mail, e.g. text, executable files), the identity of the allowed recipient if the frank is a personal electronic frank, and the number of time the frank can be used (which would allow e-mail to be forwarded a predetermined number of times).

The electronic frank can be generated previously and associated with data, for example a file or an electronic mail message, prior to the sender sending the data to an intended recipient. Alternatively it can be automatically generated as the data is being sent, for example, as described in the description above relating to FIGS. 1 and 2 of the accompanying drawings. Alternatively, some or all of this information could be generated hen the frank is attached to the e-mail, in particular, the e-mail size and content type.

The electronic frank can be associated with the data in any suitable manner apparent to those skilled in the art. However, the form the electronic frank has when associated with the data needs to be detectable by at least one apparatus in the telecommunications network, preferably an apparatus arranged to forward the data to the intended recipient, for example a mail server such as the recipients incoming mail server.

In a preferred embodiment of the invention where e-mail data is being sent, the apparatus comprises a mail server, and the electronic frank is associated with the email in the manner described herein above with reference to FIGS. 1 and 2 of the accompanying drawings. Alternatively, an internet service provider server or the email server of the sender can scan the data for the presence of an electronic frank. If the data is not franked it is not delivered to the intended recipient, and may be returned to the sender.

Cost-Value

In a preferred embodiment of the invention the electronic frank incurs a cost-value which is charged to an account associated with the sender in the manner described hereinabove with reference to FIGS. 1 and 2 of the accompanying drawings. The electronic frank conveys at least some information indicating the cost-value paid by the sender for the frank.

Both personal franks and franks provided by third parties such as trusted sources of franks may incur a cost-value by the user. The cost-value can vary according to a number of factors, for example, the number of uses of the frank, the size of the data, etc. In this way a delivery criteria in a preferred embodiment of the invention is for the cost-value of the electronic frank to be the correct value associated with the data to be sent to the recipient, i.e., to be correct for the size of data, type of data etc, bandwidth used etc.

The cost-value may be dependent on at least one of the following characteristics of the data to be transmitted to the intended recipient:

the destination address of the intended recipient of the data; the address of the sender of the data; the geographic disparity between the location of the sender's address and the location of the recipient's address, identity of the sender of the data; the number of copies of the data which are being sent by the sender of the data; the bandwidth of data; the content of the data; and the number of uses of the electronic frank.

In an equivalent manner to that described above with reference to FIGS. 1 and 2, the cost value of the electronic frank could be a monotonically increasing function of the size of the data to be transmitted.

The cost value of sending an e-mail may vary according to the number of attachments. Alternatively, a different type of frank may be attached to the e-mail or the data if, for example, the e-mail included other data as an attachment. This would enable an attachment to an e-mail to be separately franked from the e-mail itself. This would enable the attachment itself to be forwarded by a recipient to another party using another e-mail without incurring additional cost for the attachment, as the user would only need to purchase a frank for the e-mail itself. Alternatively, a electronic frank could be set to expire after one use, in which case a user would need to purchase a separate frank for the e-mail attachment. If a user is sending an attachment, the user may be given the option of purchasing a separate frank for the data which would enable the intended recipient(s) of the data to forward any attachments on to a predetermined number of further recipient(s), and/or provide the intended recipient(s) to reply to the sender at no cost of their own (i.e., effectively the electronic e-mail equivalent to providing a self-addressed, franked envelope).

Class of Delivery Options

One embodiment enables the delivery method to be affected by setting a priority for the delivery or by requesting a specified bandwidth. This can then be reflected in the cost-value of the electronic frank. For example, if the cost-value of the frank is too little for the size of the data being sent, the apparatus processing the data will either not deliver the data or deliver it over a very low bandwidth connection or assign it a very low priority. If the cost-value of the frank is correct for the size of the data being sent, it is sent over the default bandwidth connection for that recipient. If the cost-value of the electronic frank is higher than that associated with the size of the data being sent, apparatus can assign the data a higher priority and/or assign a higher bandwidth connection to the recipient.

In this way, a person who wished to send a very large data file to someone could arrange to send that file cheaply over a slow, low bandwidth connection or “pre-pay” the additional cost for a temporarily set up higher bandwidth connection. This facility requires the ability to temporarily upgrade such facilities and is likely to be more suited for sending information over broadband connections which can be upgraded temporarily (for example, by increasing the bandwidth of the broadband connection or reducing the contention on the connection) so that the sender and/or the recipient can send and/or receive the data more quickly. This enables, for example, a user to request a third party to provide a large data file (e.g. music or video files) via their normal internet connection. The third party could “frank” the data file and pre-pay for a higher bandwidth broadband connection, enabling the user to receive the data and/or e-mail more rapidly than they would using their normal default connection bandwidth.

A related delivery option would be to indicate accelerated processing of an email so that the e-mail is automatically given priority when being routed by servers. This could enable an effective delivery time to be “guaranteed”. Whilst guaranteed delivery of e-mails within a finite time limit is not generally a service which is currently demanded by consumers, in some circumstances emails can take a long time to be routed. Whilst such email is often returned to the sender if it is timed-out by a server, it can take several hours, days or even weeks before the sender receives back the email. Accordingly, it can be advantageous to have a priority e-mailing system, particularly where an e-mail may require an immediate delivery, whereas other e-mails may be less important and could be delivered several hours after they are sent. This could also be used to bounce the email back to the sender if it is not delivered within a period of time the sender has specified in the stamp.

These options could be part of the specification of the electronic stamp when purchased or alternatively incorporated in the electronic stamp when being associated with the data being sent by the sender.

Validation Process

In a preferred embodiment of the invention, the electronic frank is associated with data by suitably appending the electronic frank to the data prior to its transmission over a telecommunications network to an intended recipient at a destination address. The signal/s comprising the data and associated electronic frank data is/are sent over the telecommunications network in the usual manner with the exception that at some point the electronic frank undergoes a validation process.

The information conveyed by the electronic frank is provided in a form which, when the electronic frank has been associated with the data to be sent, can be extracted and processed by suitable apparatus in the network to validate the frank. The apparatus may comprise one or more apparatus arranged to forward the data towards the intended recipient as it is transmitted over the telecommunications network. Depending on the type of electronic frank being used and/or the e-mail scheme implemented, the apparatus should be able to perform an electronic frank validation process comprising at least the ability to check for the presence of an electronic frank.

The frank validation process may comprise more than one stage and be performed at one or more locations. In a preferred embodiment, the validation process comprises an authentication check for the information conveyed by the frank being valid and/or a check to see if the electronic frank matches the required delivery criteria for the recipient.

For example, some of the information conveyed by the frank may need to be checked for authenticity if this was not done by the stamp issuer. The stamp issuer may involve simply authenticating the identity of the sender, or authenticating the identification number of the stamp itself. Other information may be authenticated later, for example, a check may be performed if the user has pre-purchased a frank for a set cost-value that in fact that cost-value is suitable for the frank. The frank thus needs to be valid for sending the data to which it is attached to the one or more intended recipients. Finally, the frank needs to satisfy the delivery criteria.

In some embodiments of the invention, the check that the electronic frank has the appropriate cost-value for the data being sent can be performed by apparatus associated with the sender, for example, the sender's e-mail client or outgoing mail server or ISP may perform such a check. Other checks which can be performed include: does the electronic frank issue from the intended recipient? Other checks include: has the data content/sender's identity been authenticated? If not they could be further authenticated and checked by the sender's apparatus. However, one or more or all of such checks could instead be performed by apparatus associated with the intended recipient. This is shown later on FIGS. 6A, and 6C.

In embodiments of the invention where the data being sent comprises email the mail server of the recipient can perform only a simple check to verify if an acceptable electronic frank has been attached to e-mail. If so, no further checks need to be performed. Alternatively, the server may wish to check if the identity of the sender and/or the address of the sender has been authenticated by the frank issuing party. Alternatively, if a third party issues franks for a cost-value, a check can be performed either by an application associated with the sender (for example, the sender's e-mail client application, or ISP, or outgoing mail server) or a check can be performed by the mail server of the recipient to verify whether the cost-value paid is appropriate for the data being sent.

Delivery Criteria

The electronic frank allows an e-mail system to be implemented which enables a recipient of e-mail to define certain delivery criteria which the recipient's e-mail server could implement. The complexity of these criteria can affect the delivery process depending on the level of the recipient's e-mail server's available resources. Nonetheless, in a preferred embodiment the delivery criteria is simply to check for the presence of a frank. Further checks can be performed to verify if the frank bears an appropriate cost-value, and/or to verify the frank was issued by the intended recipient. The effect on the e-mail server's resources where a simple check for a frank being present is performed is less than, for example, that which would be incurred if the e-mail server had to refer to a list of addresses of potentially blocked senders or blocked keywords. Disadvantages of such schemes include the fact that the blocked sender frank lists need updating and the processing delays delivery of e-mails. Filtering e-mail based on a list of blocked content key words can exclude legitimate e-mail for a recipient, which is also undesirable. The invention enables a recipient to simply indicate that any unfranked e-mail should not be delivered. Alternatively, the invention can operate in parallel to conventional filtering schemes, for example, by setting delivery criteria which enables franked e-mail to be delivered even if it would otherwise be excluded from delivery due to the identity or address of the sender or because it contained certain keywords.

The deliver criteria therefore determine whether the recipient receives the e-mail. The delivery criteria can be set at an individual level. As an example, in a scheme where franks are issued by individuals who may only want to receive e-mail if it bears their personal frank, the frank can be validated and clear the required delivery criteria by checking if the address of the intended recipient matches the address of the issuer of the frank. A delivery criteria could thus involve one or more further validation checks being performed to verify the authenticity of the frank as well whether the information conveyed by the frank met certain delivery criteria set by the user. For example, the email client of the intended recipient may wish to check that the identity or serial number of the electronic frank is valid. Thus the validation process may occur in steps performed at one or more locations in the telecommunication network.

Preferably, the delivery criteria for the data to be transmitted to the destination address is determined by the intended recipient. Where the electronic frank was generated by a third party at least one characteristic of the data as being valid needs to be authenticated.

The delivery criteria can be set at a corporate level and/or by the individual recipient. For example, the data structure contains information which a trusted source has authenticated indicating the identity and/or the address of the sender of the e-mail. The electronic frank data structure may comprise a digital wrapper type certificate data structure.

In a preferred embodiment of the invention, a mail server is suitably configured to detect electronic franks associated with email being sent to a recipient. The mail server is configured to reject all unfranked e-mail, which facilitates processing of the email, as there is then no need for the mail server to consult a list of prohibited senders addresses etc. This increases the speed at which such mail can be processed by the mail server compared to techniques known in the art in which a list of addresses or other filter characteristics must be consulted. A similar policy can be adopted where the data being sent comprises a file, if being sent via a file transfer protocol.

If an e-mail and/or data is sent without a valid frank, the frank authentication/validation process can trigger an alarm, or fault state, and store and/or return the e-mail data to the sender (and/or copy the e-mail data to an e-mail policing body). If unfranked mail is sent to an e-mail policing body, spam e-mailers could be deterred from sending unwanted e-mails not only because of the cost, but because the e-mail policing body could ensure the frank issuers refuse to issue franks and/or increase the cost of franks to users who are found to abuse the e-mail network facility.

Frank Issuing

The electronic frank issuing application may be an application remotely accessed by the sender. Electronic franks could be issued by recipients (the personal franks described below) and provided in advance to persons who would then use the personal franks to email back to the issuer. Alternatively, the electronic frank issuing application can be controlled independently by a third party. Ideally the third party would be a trusted source who authenticates at least the identity of the sender prior to issuing the sender with the electronic frank.

When an individual user is able to issue their own franks which they then send to third parties to enable them to reply to them, the electronic franks are referred to herein as “personal franks”. Personal franks can be for one use only, or optionally designated for repeated use, e.g. back and forth between the stamp issuer and the original sender. This would enable a set of friends to communicate using each other's personal franks which they could issue freely to each other. An internet service provider (ISP) of the individual users could be used to ensure appropriate validation and authentication is performed by the e-mail servers. Where personal franks are issued, a user can provide a set of rules for their ISP to implement at the user's incoming mail server, to indicate that e-mails are only accepted, for example, if carrying a personal frank. Alternatively the rules could indicate any e-mail carrying either a personal frank or a frank issued by a trusted third party source could be received.

In a preferred embodiment of the invention, a trusted source issues an electronic frank in response to a request by a user either at the point the e-mail is sent or prior to this point, in which case the electronic frank can be thought of as an electronic “stamp” i.e. more along the lines of a conventional stamp. As has been discussed previously, the electronic frank is preferably associated with a cost-value charged to the user, either directly or deducted from an available account. The cost-value may depend on certain criteria associated with the identity of the sender, the characteristics of the data associated with the intended use of the frank, the period of validity of the frank. The use of the frank can also be subject to certain limitations, for example that the purchaser uses the frank themselves, or that the frank can only be attached once to an e-mail. The trusted source is a third party who will, in a preferred embodiment, have independently authenticated the sender's identity and address details at some point prior to issuing one or more franks to the sender.

In a preferred embodiment, the frank is associated with a monetary cost-value and the trusted source only issues a frank subject to payment of the associated cost-value. The association with a monetary cost-value could depend on the disparity between the locations of the sender's address to the intended destination address. For example, a corporation could provide electronic franks where the cost-value ideally comprises a monetary value only if a frank enables a sender to send data outside the corporations own intranet. In other embodiments, for example, such as are described herein above with reference to FIGS. 1 and 2 of the accompanying drawings, the cost value, can comprise a number of “points” deducted from an allocation. This embodiment is preferred when data sent to recipients within the same corporate intranet as the sender.

In embodiments where electronic franks may be purchased without requiring any authentication of the sender's identity or address, the charged cost-value can be set sufficiently high to deter the sending of unsolicited e-mail to large number's of recipients.

### Some Preferred Embodiments

FIG. 4 of the accompanying drawings shows schematically steps in a method of sending data over a telecommunications network according to the invention. The term “telecommunications network” is used herein to refer to any suitable network for conveying data electronically including a computer (i.e. data only) network and/or a communications network (which can also have the facility to offer voice and other telephony services in addition to data transmission). The data to be sent over the network in the best mode contemplated of the invention comprises any data which can be transmitted using an electronic mail messaging application (i.e. by e-mail). In other embodiments of the invention, file transfer or message based communications such as SMS communications over wired and/or wireless networks may be franked. The invention is intended therefore to enable any data transmitted over a telecommunications network to be franked where a receiver of such data may wish to control what kind of data they receive to prevent unsolicited data being sent.

A user is able to associate the electronic frank with the data to be sent by using a suitably configured terminal. For example, such a terminal as has been described already herein with reference to FIGS. 1 and 2 of the accompanying drawings. A terminal may comprise any suitably configured device capable of communicating data electronically over a telecommunications network. For example, any computer-type device, portable computer-type device, mobile telephone type device, fax-machine type device, or personal digital assistant type device. The terminal must also have suitable means to associate an electronic frank with the data, for example, by providing a suitable data transmission client application which has the ability to associate an electronic frank with data to be sent prior to the data being transmitted.

A user of such a terminal is able to perform a method of sending franked data over a telecommunications network to an intended recipient at a destination address comprising the steps of: preparing data for transmission, obtaining an electronic frank issued by an electronic frank generating source, and attaching the electronic frank to the data prior to sending the data over the telecommunications network. The cost-value associated with the frank may rise monotonically according to the size of the data to be transmitted, for example, if an e-mail is being sent with several attachments.

In FIG. 4, further steps in a method of sending data over a telecommunications network are shown. In FIG. 4, a user purchases an appropriate electronic frank, for example an electronic “stamp”, in step 301. Having purchased a frank for an appropriate cost-value, the sender attaches the frank to the e-mail (step 302). The e-mail is then sent by the e-mail client of the sender in the normal manner (step 303). An e-mail client is defined to be any program or suite of programs arranged to enable a user to read and send e-mail by downloading mail from a server for reading, and to send mail to other computers.

The franked e-mail is then sent by the e-mail client to an associated server, for example, an outgoing e-mail server such as a Simple Mail Transfer Protocol (SMTP) server. In this context a server is defined to comprise a computer (or software package) in a network that is used to provide particular services to other computers. The term e-mail server may refer to either an SMTP or POP3 or IMAP as appropriate.

The e-mail received by the server (step 304) may be sent on through the network to the intended recipient's e-mail server, and/or be subjected to various verification processes and checks en route. For example, the sender's outgoing e-mail server may perform a check to ensure that the e-mail has been properly franked (step 305). The frank may be checked only when it is received by a server associated with the intended recipient. Alternatively, any server which processes the e-mail may automatically perform additional checks to ensure the electronic frank is valid by examining the information it contains.

If a frank is not attached, the e-mail is returned by the server performing the check to the sender and/or an indication is sent back to the sender that the e-mail will not be delivered (step 305).

If a frank is found, it may be subjected to a further validation check (step 306), before the e-mail continues to be delivered to the recipient (step 307).

FIG. 5 shows schematically steps in an electronic frank (or equivalently an electronic frank) validation process 501 for an electronically franked data. FIG. 5 shows only a few sample checking steps, and it will be apparent to those skilled in the art that other checks can be performed.

The entire validation process comprises a check procedure on the authenticity of the information conveyed by the electronic frank (step 502 in FIG. 5) and a subsequent check procedure for whether the electronic frank complies with predetermined deliver criteria which allow the franked data to be delivered to a recipient (steps 503 to 506 in FIG. 5). The validation process 501 may take place at different locations in the telecommunications network or be completed at a single location. In FIG. 6A, the authentication steps are performed by apparatus associated with the sender, and the delivery criteria checking process is performed by apparatus associated with the recipient. An alternative embodiment of the invention is shown schematically FIG. 6B where the validation process is performed by apparatus associated with the sender. Another alternative embodiment of the invention is shown in FIG. 6C where the validation process is performed by apparatus associated with the recipient.

FIG. 6A shows schematically an embodiment of the invention where the authenticity check procedure and delivery criteria check procedure are performed by separate server apparatus in the network. For example, the sender's outgoing e-mail server or ISP could check for the authenticity of the frank and the intended recipient's incoming e-mail server could check to see whether the electronic frank meets the recipient's delivery criteria. It is also possible (not shown in any of FIG. 6A, 6B, or 6C) for the apparatus performing the franking process or the frank issuing party to perform the only authentication of the electronic frank. The electronic frank itself is then “trusted” by the recipients mail server. In such embodiments of the invention, the validation process comprises simply ensuring the delivery criteria are met. In embodiments of the invention where no authentication needs to be done by apparatus associated with the recipient, data can be much more rapidly processed. Simple delivery criteria including, for example: is an electronic frank attached? and/or has an authenticated electronic frank been attached? In such embodiments of the invention, the recipient's server apparatus is able to more rapidly process franked e-mail as it is received as it no longer has to authenticate any information in the electronic frank. The authentication can be achieved in the same way as information in a conventional digital file wrapper certificate is examined for authenticity.

A person skilled in the art will realise the steps shown in FIG. 5 are simply indicative of various potential validation queries which would confirm to the set of predetermined rules to ensure the frank is valid, and as such the validation rules need not be restricted only to the individual checks shown or the order shown.

In one embodiment of the invention, the authentication process comprises a subset of checks in the validation process which relate to information which the sender's e-mail server(s) can verify. The validation process shown in FIG. 5 shows step examining the frank itself for authenticity.

For example, is the frank from a trusted source recognised by that server (step 503 in FIG. 5)? If so, in some embodiments of the invention, some further checks may need to be performed or alternatively, the frank can be accepted per se. Once the frank has been verified to have been issued by a trusted source frank and the e-mail may be delivered to the recipient. If the trusted source is not recognised, for example if the e-mail was instead perhaps provided by an unrecognised source, additional steps to authenticate the frank may be performed or the frank may be rejected and the e-mail returned to the sender.

Other checks to perform which are shown schematically in FIG. 5 include verifying if the frank has expired if it is subject to a time frank (step 503), if the frank has it been used before (i.e., attached to a previous e-mail send to the sender), or if it has the correct cost-value. The correct cost-value may depend on the for the type of e-mail content sent and/or on the bandwidth used by the e-mail (steps 505,506). A frank could be designated for a specific recipient (step 504), in which case, it may be possible to indicate in the frank if the content is suitable for children etc in step 505.

A frank could be automatically attached by the sender's outgoing mail server(s) if required and the appropriate cost-value charged to the sender's account. Alternatively an appropriate application running remotely from the server which interfaces with the server to perform franking and/or frank validation. This embodiment could facility the franking process for corporate e-mail users. Alternatively, (as is shown by the dashed lines in FIGS. 6A and 6B), the e-mail could be returned to the sender or a notification sent to the user that the e-mail will not be delivered if it is unfranked or inappropriately franked.

The validation process may apply criteria which are different for different sets of intended recipients. In this way, company e-mails (internal e-mail) could be sent within a particular corporate intranet without a frank. Alternatively, a frank could be required but set to a dummy value or assigned ‘no-cost’ for internal e-mail or a nominal cost-value (or non-monetary cost value) could be considered appropriate. However, e-mails sent outside the corporate intranet would require a valid frank.

In such embodiments, e-mail which has not been validly franked by the user directly could be automatically franked if the e-mail is to be sent out of a corporate intranet. In embodiments of the invention where an application associated with the sender's e-mail client generates the electronic franks and assigns a cost-value to them, the sender of the e-mail could have a cost-value account set up from which the cost-value of any e-mail franks is automatically deducted. In this such embodiments, if sufficient cost-value was not available in the sender's account the e-mail could be returned to the sender's e-mail client. Such accounts could automatically deduct cost-value amounts whenever an e-mail is sent by a user, so that the franking process itself is automatic and a user is never required to deliberately “attach” a time-frank.

Thus, whenever e-mail is sent to someone whose account resides on the same set of mail servers, the SMTP server could simply direct the mail to the local incoming mail server (e.g. a POP3 or IMAP server), where it will be delivered to the appropriate e-mail account. In this case, the SMTP server (or any franking application interfacing with the server) may add a “null” cost-value frank to authenticate the source of the e-mail so that this e-mail will be able to pass through the local incoming mail server.

In the best mode of the invention currently contemplated by the inventor, e-mail received by the intended recipient's incoming e-mail/data server is checked for an appropriate electronic frank. The electronic frank must satisfy delivery criteria before it is delivered. The delivery criteria may comprise simply for the data to be franked, or for the frank to contain certain parameter-values, for example, to indicate an accepted source, or content, or to have at least a sufficient cost-value. The delivery criteria may be defined by the intended recipient, or by their ISP or at a corporate level, or by the frank issuing body (including if a personal frank, the intended recipient who has issued the frank).

More complex authentication rules can be implemented. For example, the frank can be examined to ensure that the frank issuing authority is authentic, that the frank serial number is authentic, that the frank is within its expiry criteria (e.g., before an expiry date, and/or that it has not exceeded any predetermined number of uses).

Referring, again to FIGS. 6A, 6B, and 6C of the accompanying drawings, these figures show various embodiments of the invention comprising apparatus arranged to implement steps in method of sending franked data according to the invention. The apparatus comprises software components and/or hardware components as appropriate to implement the invention.

In FIG. 6A, a sender uses an appropriate apparatus (401) comprising a computational device and software (for example, a personal computer running an appropriate e-mail client such as Microsoft™ Outlook™ etc., but alternatively, a mobile device such as a mobile computer or a mobile phone providing with an e-mail facility) to compose their e-mail using an appropriate e-mail client.

Franking apparatus (402) performs a franking process which attaches an electronic frank to the e-mail. This franking apparatus may be interfaced with by the sender's e-mail client and comprise an application run remotely under the independent control of a trusted third party.

Once generated the electronic frank may be associated (possibly by integrating it with the e-mail as the frank is generated, or alternatively, if the electronic comprises a suitable file structure, simply by adding it as an attachment to the e-mail) by any suitable program. This program may be an application which the sender's e-mail client interfaces with prior to or as the e-mail is being sent, or may comprise a suitable program integrated with the client e-mail software.

In a preferred embodiment of the invention, a visual indication is provided by the client e-mail application that the e-mail to be sent has been franked. Preferably an indication of the cost-value of the electronic frank is shown which is visible to the user.

The franked e-mail is then sent to the sender's outgoing e-mail server 403. In the case where e-mail is to be sent outside an intranet, the sender's server(s) process the e-mail and send it on to the recipient's incoming e-mail server 406 via communications network 405. The recipient's server(s) then processes the received e-mail and forwards the e-mail to the receiver 408.

The sender's server(s) and the recipient's server(s) can either individually or in combination ensure that e-mails are appropriately franked by performing an appropriate frank validation process.

In FIG. 6A, the validation process is partly performed by apparatus at the sender's end and partly by apparatus at the recipient's end. In FIG. 6A, outgoing server 403 associated with the client e-mail application performs a frank authentication process (described in more detail later), which checks that the frank the user has attached to the e-mail is valid (404).

The e-mail is either returned to the sender (if the e-mail is not franked or if the frank is not valid, for example, if the cost-value associated with the e-mail is not sufficient) (as shown by the dashed line) or sent over the telecommunications network 405 to the intended recipients incoming mail server 406. In a preferred embodiment of the invention, as all details of the frank have already been authenticated, the recipient's incoming mail server 406 needs to only perform a simple check to verify the e-mail is franked (407), prior to sending the mail on to the recipient's e-mail client application (408). In embodiments of the invention where a trusted third party supplies the frank, the validation process performed by the incoming server may simply comprise detecting the frank is from the trusted source, for example, by verifying a frank identification number. This embodiment is particularly useful where franks are obtained from (i.e. are issued by) a designated trusted source (in the same manner that digital certificates are issued by a trusted source), so that any e-mail which has been franked is considered suitable for delivery. Alternatively, more complex delivery criteria may be applied, for example, in schemes where a personal frank is issued, a check may be performed at either the outgoing and/or incoming server to ensure the frank was issued by the intended recipient.

Alternatively, in FIG. 6B, the sender's outgoing mail server 403 can perform the complete validation service and no further validation checks are then required by the incoming mail server 406 of the recipient. In the method of sending data represented by the apparatus shown in FIG. 6B, therefore, an e-mail cannot be sent without a frank. This process is suitable for embodiments of the invention where the electronic e-mail “frank” is assigned a cost value which is dependent on parameters that the outgoing server can validate.

In FIG. 6C, a mail server associated with the recipient performs all validation processes for the electronic frank. This is suitable where the receiver's e-mail server needs to validate certain parameters associated with the electronic frank.

Frank Attachment

As has been described briefly above, the process of attaching the “frank” can comprise simply adding the frank in the same way that any other data attachment is attached to the e-mail. Alternatively, a particular application may be run (either within the sender's usual e-mail client software application or externally to the usual client software application) to attach an appropriate frank. Franks may be attached automatically as e-mail is sent so that the process appears transparent compared with sending e-mail in the normal way without a frank to the sender. This latter process would require the cost-value associated with the frank to be automatically deducted from an account appropriate set up to charge the cost-value of the e-mail sent. Thus the cost-value may be deducted at the time the user sends the e-mail, or may be deducted prior to the franks being used. This is provided the franks themselves indicate their cost-value to the sender so an appropriate stamp can be selected by a sender for a particular data/email transmission.

If the franks themselves have a cost-value, then it becomes possible for a user to send a frank to another party to enable that party to “freely” reply to the sender.

If the user forgets to frank their e-mail, they can be prompted by their e-mail program to attach an electronic frank prior to sending the e-mail. Alternatively, a sender's e-mail server could return any e-mail which a user has not franked for proper franking.

A Data Transmission Scheme Enabling Bandwidth on-demand Access to the Internet

Another embodiment of the invention relates to the provision of internet access per se or the provision of a certain bandwidth of internet access according to the value of franks a user uses on-line for data communications. For example, an ISP could provide internet access and/or an e-mail service for users who send and receive only franked e-mails and data. This would mean that a user would not need to have prearranged for access with an ISP prior to sending the e-mails, as they could compose an e-mail and simply attach an electronic frank of sufficient value to “purchase” the internet access for a certain duration. Alternatively, the franks could be purchased to ensure that the sender or receiver of a large amount of data/e-mail upgraded their bandwidth for a certain duration.

This could be done using an application arranged to receive specific codes previously purchased by the user, in the manner a telephone top up card is (either a scratch-top up card or e-top up card) used to provide codes which generate funds in a telephone users account. Alternatively, a user can, by telephoning a service centre, enable the user's client application to attach franks whose cost-value is deducted from that amount.

In such embodiments, the ISP could generate revenue by the franks issued by the franking process rather than charging for line access on a conventional charging structure. For example, conventional charging structures can require a user to sign up for a years worth of high speed access. However a user may not know if they would utilise the connection bandwidth fully. The present scheme of providing electronic franks enables a user to either purchase a connection completely or to have a low-speed connection and buy franks whenever they wanted to increase their bandwidth to send or receive larger amounts of data. Franks could also be attached by a server to data which would upgrade the connection to a user. For example, a person could purchase a music file from a server and request a high-speed download to their e-mail inbox. The server would then attach an appropriate electronic frank to the music file to be downloaded which would enable the recipient to receive the music file more quickly by prioritising its delivery. This could also mean that the bandwidth of the user's connection was upgraded if the user had a broadband connection with an appropriate upgrade facility.

Reciprocal agreements could be set up between ISP's so that e-mails franked by one ISP would be delivered to e-mail addresses supported by another ISP. This would also enable franks to be bought independently from trusted third party sources, such franks could be valid for all ISP's, each ISP receiving revenue from the third party source for accepting e-mails carrying that third party's franks.

Although the franking validation rules are envisaged in the above embodiments as being processed at various mail servers, the franking validation rules could be processed by mail as it is received by the recipients e-mail client, in particular where a recipient has an “always on” their connection, i.e. an Asymmetric Digital Subscriber Line (ADSL) or other broadband connection. The sender's e-mail client could also incorporate the authentication process, so that it would not be possible for e-mail to be sent without a valid frank for a particular e-mail. The senders e-mail client could also process outgoing e-mail to automatically frank e-mail as it is being sent. If e-mail is franked automatically, a cost-value could be automatically associated with the e-mail by the e-mail client.

Inhibiting Spam Email

In embodiments where personal franks are issued by a first party to a second party, spam is prevented as the first party can simply set the number of uses of the franks it issues to a single use and then control the distribution of their personal franks appropriately. Alternatively, a person could issue personal franks but charge for them. In this way, a recipient of an e-mail is able to gain revenue by issuing their own franks. Marketing “spammers” etc., would then pay to deliver unsolicited e-mail to people who issued such personal franks. Where a trusted third party issues the franks, if the cost value of the frank is sufficiently large, or if a sender is blacklisted by the trusted source as having send spam e-mail or otherwise having abused an e-mail system, the sending of “spam” e-mail will be inhibited.

The preferred embodiment of the invention proposes the use of an electronic frank to be attached to data comprising an electronic mail message. However, the data may instead comprise audio, video or multi-media applications and/or data or comprise text messages sent via the SMS mobile text messaging service or any application where recipients of electronically conveyed data which to filter out unwanted or spam data they would otherwise receive.

Those skilled in the art will appreciate that spirit and scope of the invention described above is not limited to the specific embodiments recited but is instead intended to be that captured by the accompanying claims.

1-42. (canceled)

43. An authentication scheme for a data transmission system the system comprising:
a user issuing an electronic frank to senders of data for which the user is the intended recipient;
associating the electronic frank in use with data to be transmitted over a telecommunications network to an intended recipient at a destination address;
validating the electronic frank using information contained by the electronic frank which is arranged to be authenticated;
processing the electronic frank to confirm if the frank meets at least one predetermined delivery criteria, the electronic frank being thus validated prior to the data being transmitted to the destination address, wherein the intended recipient determines said at least one predetermined delivery criteria for data to be transmitted to the intended recipient.

44. A scheme as claimed by claim 43, wherein the data to be transmitted comprises an electronic mail message.

45. A scheme as claimed in claim 44, wherein the electronic frank comprises a data attachment to the electronic mail message.

46. A scheme as claimed in claim 43, wherein the electronic frank data structure comprises a digital wrapper certificate type data structure.

47. A scheme as claimed in claim 43, wherein the electronic frank is associated with a predetermined cost-value.

48. A scheme as claimed in claim 47, wherein at least one predetermined criteria to which the electronic frank must conform is for the cost-value of the electronic frank to be the correct value associated with the data to be sent to the recipient.

49. An electronic frank as claimed in claim 48, wherein the cost-value is determined by the intended recipient.

50. An electronic frank arranged to be capable of being attached to data arranged for use in an authentication scheme as claimed in claim 43, the data comprising e-mail to be sent by a user of an electronic mail client application to an intended recipient via a telecommunications network, the electronic frank having a data structure which conforms to a predetermined format which enables certain delivery criteria to be applied when the electronic frank is processed by apparatus in the network, wherein the delivery criteria determine whether the recipient receives the e-mail.

51. An electronic frank as claimed in claim 50, wherein the electronic frank is associated with a cost-value dependent on a set of at least one predetermined characteristics of the e-mail to which the frank is to be attached.

52. An electronic frank as claimed in claim 50, wherein the electronic frank is associated with a cost-value dependent on a set of at least one predetermined characteristics of the e-mail to which the frank is to be attached and in which the electronic frank is issued is computed by an application which is operable to increase the cost value in the event of the e-mail being marked with a marker indicative of the priority of transmission to the intended recipient.

53. A terminal arranged to enable a user to send data electronically to an intended recipient over a telecommunications network, the terminal comprising:
means for generating data electronically;
means operable to associate an electronic frank as claimed in claim 8 with the data prior to its transmission;
means for displaying to a user of the terminal a visual indication representative of the electronic frank; and
means for transmitting the franked data via a telecommunications network to a destination address.

54. A terminal as claimed in claim 53, wherein the terminal further comprises means operable to authenticate the information conveyed by the electronic frank prior to the franked data being sent by the apparatus and to include this authentication information within the data structure of the electronic frank.

55. A terminal as claimed in claim 53, wherein the terminal further comprises means operable to authenticate the information conveyed by the electronic frank prior to the franked data being sent by the apparatus and to include this authentication information within the data structure of the electronic frank, and wherein said at information authenticated includes the address of the sender and/or the identity of the sender and/or that the franking cost-value of the electronic frank is the appropriate amount for the data being sent.

56. A terminal as claimed in claim 53, wherein the means operable to associate an electronic frank with the data comprises means to automatically generate the frank and to automatically attach the frank to any data to be transmitted.

57. Apparatus forming part of a telecommunications network and arranged to forward e-mail to a destination address, the apparatus further comprising:
data validation means arranged to validate an electronic frank according to an authentication scheme as claimed in claim 43, wherein the electronic frank has been attached to e-mail to be sent to a recipient over a communications network.

58. Apparatus as claimed in claim 57, wherein the apparatus comprises the outgoing e-mail server of the user.

59. Apparatus as claimed in claim 57, wherein the apparatus comprises the incoming e-mail server of the recipient of the e-mail.

60. Apparatus as claimed in claim 57, wherein the data validation means performs a validation process which authenticates the electronic frank.

61. Apparatus as claimed in claim 57, wherein the apparatus performs a delivery criteria check process by processing an electronic frank according to predetermined delivery criteria, wherein said predetermined delivery criteria determine if the e-mail is to be delivered to the recipient.

62. Apparatus as claimed in claim 57, wherein the apparatus performs a delivery criteria check process by processing an electronic frank according to predetermined delivery criteria, wherein said predetermined delivery criteria determine if the e-mail is to be delivered to the recipient, and wherein the delivery criteria is whether an electronic frank is attached having an appropriate cost-value for the data being sent.

63. A method of generating an electronic frank arranged for use in an authentication scheme as claimed in claim 43, the electronic frank being associated with a unique identifier and comprising a data structure conforming to a predetermined data template, the method comprising the steps of:
receiving a request for an electronic frank from a requesting entity;
querying the requesting entity for information to determine at least one parameter-value to be contained within the data structure;
processing the information provided by the requesting entity;
generating a data structure using the processed information, the data structure containing the at least one parameter-value pair associated with a characteristic of the data to be sent; and
issuing the electronic franking data to the requesting entity.

64. A method of filtering data sent over a telecommunications network towards an intended recipient, the method comprising, at a communications apparatus arranged to forward the data towards the intended recipient, the steps of:
receiving the data for forwarding to the intended recipient;
processing the data to determine if it is associated with an electronic frank to implement an authentication scheme as claimed in claim 43; and,
if no electronic frank is found and/or if the electronic frank has a data structure which does not conform to a set of at least one predetermined criteria preventing the data from being forwarded to the intended recipient, or otherwise
forwarding the data to the intended recipient.

65. A mail server arranged to implement the method of claim 64.

66. A firewall component arranged to implement the method of claim 64.

67. A signal in a communications network, the signal comprising data associated with an electronic frank implementing an authentication scheme according to claim 43.

68. Software comprising a suite of one or more computer programs, the software being provided on a carrier medium and arranged in use to be run on one or more computer type devices to implement the scheme according to claim 43.

69. Software comprising a suite of one or more computer programs, the software being provided on a carrier medium and arranged in use to be run on one or more computer type devices to implement a method according to claim 63.

70. A method of providing bandwidth for a data transmission service over a communications network to a user who does not have prearranged access to the communications network at that bandwidth, the method comprising the steps of:
associating an electronic frank containing information arranged to be authenticated whereby the electronic frank can be validated and processed to confirm if the frank meets at least one predetermined delivery criteria, the electronic frank being thus validated prior to data being transmitted to an intended recipient at a destination address, with data to be sent using said data transmission service, said electronic frank being associated with a cost-value;
providing a data transmission service to send and/or receive franked data over said communications network at said bandwidth.

71. A method as claimed in claim 70, wherein the intended recipient issues the electronic frank to the user, the electronic frank in use arranged to be associated with data to be transmitted over a telecommunications network to the intended recipient at the destination address.

72. A method as claimed in claim 70, wherein the intended recipient issues the electronic frank to the user, the electronic frank in use arranged to be associated with data to be transmitted over a telecommunications network to the intended recipient at the destination address, and wherein the intended recipient determines said at least one predetermined delivery criteria for data to be transmitted to the intended recipient.

73. A method as claimed in claim 70, further comprising the step of said user obtaining said electronic frank prior to associating said electronic frank with said data to be sent.

74. A method as claimed in claim 70, wherein said user purchases said electronic frank prior to associating said electronic frank with said data to be sent.

75. A method of providing a predetermined bandwidth for a data transmission service to a user who does not have prearranged access to a communications network at that bandwidth, the method comprising the steps of:
enabling the user to indicate the desire to send data via a data transmission client application;
enabling the user to purchase an electronic frank containing information arranged to be authenticated whereby the electronic frank can be validated and processed to confirm if the frank meets at least one predetermined delivery criteria, the electronic frank being thus validated prior to data being transmitted to a destination address of an intended recipient,
wherein the electronic frank is associated with said data and a cost-value associated with the electronic frank has been charged to the user, wherein the association of the electronic frank with the data enables the data transmission client application to send and/or receive franked data via a server connected to the communications network at the predetermined bandwidth.

76. A method as claimed in claim 70, wherein the data comprises e-mail.

77. Software comprising a suite of one or more computer programs, the software being provided on a carrier medium and arranged in use to be run on one or more computer type devices to implement the methods according to claim 70.
